(19) United States
(12) Patent Application Publication
(10) Pub. No.: US 2015/0213365 A1
(43) Pub. Date: Jul. 30, 2015

(54) METHODS AND SYSTEMS FOR CLASSIFICATION OF SOFTWARE APPLICATIONS

(71) Applicant: Shine Security Ltd., Herzlia Pituach (IL)

(72) Inventors: Ianir IDESES, RaAnana (IL); Assaf NEUBERGER, RaAnana (IL)

(21) Appl. No.: 14/608,340

(22) Filed: Jan. 29, 2015

Related U.S. Application Data
(60) Provisional application No. 61/933,366, filed on Jan. 30, 2014.
(60) Provisional application No. 61/942,049, filed on Feb. 20, 2014.
(60) Provisional application No. 61/950,304, filed on Mar. 10, 2014.
(60) Provisional application No. 61/983,477, filed on Apr. 24, 2014.

(51) Int. Cl. G06N 5/04; G06N 99/00; H04L 29/06

(52) U.S. Cl. CPC G06N 5/04; H04L 63/14; G06N 99/005; H04L 67/42

(57) ABSTRACT

There is provided a computer-implemented method for identifying functions within software applications, comprising: receiving a software application for identification; automatically identifying third-party data acquisition functions embedded within the software application, the third-party data acquisition functions communicating with a remote third-party server; and providing the identified third-party data acquisition functions for the software application.

### RELATED APPLICATIONS

This application claims the benefit of priority under 35 USC §119(e) of U.S. Provisional Patent Application Nos. 61/933,366 filed Jan. 30, 2014, 61/942,049 filed Feb. 20, 2014, 61/950,304 filed Mar. 10, 2014 and 61/983,477 filed Apr. 24, 2014, the contents of which are incorporated herein by reference in their entirety.

### BACKGROUND

The present invention, in some embodiments thereof, relates to methods and systems for classification and, more specifically, but not exclusively, to methods and systems for classification of software applications.

Mobile devices such as Smartphones have increased in software sophistication. Contemporary mobile operating systems allow installation of third-party applications. Some operating systems use a walled garden approach. Other operating system platforms allow installation of any application, for example, either from an official application store, or any other source. Furthermore, some platforms allow installation of applications from any computer in a process that is sometimes called sideloading.

As a direct consequence of the openness to third-party applications (apps), many vendors have started developing for these platforms. In order to support the development of applications, mobile advertising networks have emerged. Together with the development of ad networks, adware (advertisement software) have also begun to crop up. These adware take advantage of existing ad networks and create applications whose main purpose is display of ads on the device. These ads may take the form of banners, intrusive notifications and click hijacking.

Solutions for detection of such adware applications are available, for example, in the form of anti malware software. Such software relies mostly on signature based algorithms. These can take the form of black lists of applications or file signatures.

### SUMMARY

According to an aspect of some embodiments of the present invention there is provided a computer-implemented method for identifying functions within software to applications, comprising: receiving a software application for identification; automatically identifying third-party data acquisition functions embedded within the software application, the third-party data acquisition functions communicating with a remote third-party server; and providing the identified third-party data acquisition functions for the software application.

Optionally, the method further comprises automatically classifying the software application based on the identified third-party data acquisition functions.

Optionally, automatically identifying comprises automatically identifying concealed embedded third-party data acquisition functions based on a preselected group of classification features extracted from the software applications, the preselected group of classifying features corresponding to the concealed embedded third-party data acquisition functions.

Optionally, classifying comprises classifying by a classifier, the classifier evaluating the software application based on a selected group of extracted classifying features, the extracted classifying features selected from a plurality of features so that the extracted classification features are based on third-party data acquisition functions embedded within the software application.

Optionally, the third-party data acquisition functions are provided as part of a software development kit (SDK) for development of the software application.

Optionally, the third-party includes at least one member of a group consisting of: ad network, advertiser, hacker, spy, market information collector, malicious party.

Optionally, the third-party data acquisition functions are function calls to the third-party remove server and/or application programming interfaces (API) communicating with the third-party remote server.

Optionally, the software application is received at a client terminal for local run-time classification by the client terminal.

Optionally, the method further comprises providing a classification type denoting one of a plurality of ad networks.

Optionally, the method further comprises installing or removing the software application based on the identified third-party data acquisition function.

According to an aspect of some embodiments of the present invention there is provided a computer-implemented method for generating data for identifying embedded third-party data acquisition functions within software applications on a client terminal, comprising: identifying, at a central server, a plurality of features from each of a plurality of training software applications, each of the plurality of training software applications contains third-party data acquisition functions embedded therein, the third-party data acquisition functions communicating with a remote third-party server, the embedded third-party data acquisition functions being concealed so that similar third-party data acquisition functions corresponding to a same third-party have different identities between at least two training software applications embedding concealed third-party data acquisition functions from the same third-party; identifying a group of classifying features from the plurality of features, the group of classifying features corresponding to the embedded third-party data acquisition functions within each of the plurality of training software applications; and providing the group of classifying features to a client terminal, for identification of third-party data acquisition functions embedded within a software application locally by the client terminal.

Optionally, the method further comprises generating a classifier for evaluating software applications based on the group of classifying features; and providing the classifier to a client terminal, for feature extraction and classification of a software application locally by the client terminal.

Optionally, the group of classifying features is selected to correspond to concealed embedded third-party data acquisition functions.

Optionally, the classifier is a multiclass classifier for classifying the software application into one of a plurality of different third-parties.

Optionally, the classifier is a single-class classifier for classifying the software applications as having third-party data acquisition functions embedded therein or not.

Optionally, identifying a group of classifying features from the plurality of features comprises: labeling each of the plurality of training software applications with a predetermined classification category; generating a set of values, by applying a machine learning software module to the plurality of features and corresponding labels, certain values within the set of values corresponding to certain features of the plurality of features; identifying the group of classifying features based on a sub-set of values from the set of values, each classifying feature from the group of features corresponding to at least one value from the sub-set of values, the set-of values corresponding to the embedded third-party data acquisition functions.

Optionally, the set of values includes at least one member of a group consisting of: a vector of coefficients, a matrix of coefficients, a set of decision rules, a tree of decision rules.

Optionally, identifying comprises identifying the sub-set of values as the highest ranked absolute values of the set of values.

Optionally, the method further comprises identifying classifying types of each of the values of the set of values, and identifying comprises selecting the highest ranked absolute values of the set of values for each identified classification type.

Optionally, identifying comprises identifying groups of similar third-party data acquisition functions based on cardinality within the set of values.

According to an aspect of some embodiments of the present invention there is provided a system for identifying third-party data acquisition functions embedded within software applications, comprising: a client terminal comprising: a client processor; a first non-transitory memory having stored thereon program modules for local instruction execution by the client processor, comprising: an identification module for automatically identifying third-party data acquisition functions embedded within the software application, the third-party data acquisition functions communicating with a remote third-party server.

Optionally, the system further comprises a classification module for automatically classifying the software application based on the identified third-party data acquisition functions embedded therein, to generate a classification type for the software application.

Optionally, the client terminal further comprises a client network node for communicating with a server network node interface over a network.

Optionally, the system further comprises: a network connected central server; a second non-transitory memory having stored thereon program modules for instruction execution by the central server, comprising: a module for generating classification data for identifying third-party data acquisition functions embedded therein, and/or classifying software applications based on third-party data acquisition function embedded therein; a server network node interface for providing the classification data to a client terminal, for identification of third-party data acquisition functions within a software application and/or classification of the software application locally by the client terminal.

Optionally, the network connected central server further comprises: a module for identifying a plurality of features from each of a plurality of training software applications, each of the plurality of training software applications contains third-party acquisition functions embedded therein, the third-party acquisition functions communicating with a remote third-party server, the embedded third-party acquisition functions being concealed so that similar third-party acquisition functions corresponding to a same third-party have different identities between at least two training software applications embedding concealed third-party acquisition functions from the same third-party; a module for identifying a group of classifying features from the plurality of features, the group of classifying features corresponding to the embedded third-party acquisition functions within each of the plurality of training software applications; and a module for generating a classifier for evaluating software applications based on the group of classifying features.

Optionally, the client terminal further comprises a feature extractor module for local run-time execution by the client processor, the feature extractor module programmed for extracting features from a software application based on a group of classifying features received from a central server.

Optionally, the system further comprises a labeling module for labeling of software application with one of a plurality of ad networks, the labeled software applications used for generating a multi-class version of a classifier, the labeling module stored on the second memory.

Optionally, the system further comprises a feature extractor module stored on the second memory, the feature extraction module for extraction of features of software applications into complete feature vectors, the group of classifying features selected from the complete feature vector.

Optionally, the client terminal is resource limited, having insufficient resources for local run-time extraction of a complete feature vector of a plurality of features from the software application.

Optionally, the client terminal includes at least one member of a group consisting of: mobile phone, Smartphone, tablet, portable media player, e-reader.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of generating classification data, in accordance with some embodiments of the present invention;

FIG. 2 is a flowchart of a method of identifying third-party data acquisition functions and/or classifying software applications, in accordance with some embodiments of the present invention;

FIG. 3 is a block diagram of a system for generating classification data, identifying third-party data acquisition functions, and/or for classifying software applications, in accordance with some embodiments of the present invention; and

FIG. 4 is a block diagram of a network node for generating classification data, in accordance with some embodiments of the present invention.

### DETAILED DESCRIPTION

An aspect of some embodiments of the present invention relates to systems and/or methods for automatically classifying software applications based on embedded third-party data acquisition functions within the software applications. Optionally, the third-party data acquisition functions embedded within the software application are automatically identified. Optionally, the software applications are automatically classified based on the identified third-party data acquisition functions.

An aspect of some embodiments of the present invention relates to systems and/or methods for automatically identifying third-party data acquisition functions embedded within the software application. The detected third-party data acquisition functions may be, for example, used to classify the software application, displayed to the user for further action, provided as input to other software algorithms for further processing, and/or other actions may be taken.

As used herein, the term third-party means an entity external to the software application. The third-party is, for example, an ad network (e.g., which may match advertising space on the software application with an advertising entity), an advertiser (e.g., directly advertising itself on the software application), a hacker (e.g., which provided a weakness in the software application for hacking), a spy (e.g., which provided spyware in the software application), a malicious party (e.g., which provided malware in the software application), a market information collector (e.g., which provided a module for collecting market information within the software application), or other third-parties.

As used herein, the phrase data acquisition function (or acquisition function) means a locally embedded function (i.e., within the software application) that obtains functionality and/or data from the third-party. The functionally and/or data may be obtained during run time of the software application. The third-party acquisition functions (e.g., when embedded in the software application installed on a client terminal) optionally communicate with a remote server of the third-party. For example, the embedded function may download a banner ad from an ad network server, and display the banner ad while the software application is running Embedded functions may download and display, for example: banners, ads, pop-ups, search engine results, announcements, or other data. Alternatively or additionally, embedded functions may upload data to the third-part server, for example: web-sites visited by the user, passwords entered by the user, applications executed by the user, user activity of the software application, user activity of the client terminal, user activity of other software applications, and/or other data. Such software applications having embedded third-party acquisition functions may be undesirable to the end user. By detecting software applications with embedded third-party acquisition functions, installation of the software application may be prevented or selectively controlled, for example, software application with third-party acquisition functions from certain third parties may be allowed for installation.

The third-party acquisition functions may be provided as part of a software development kit (SDK) by the third-party, for example, function calls, application programming interfaces (API), or other acquisition functions for embedding within the software application. The acquisition functions may communicate with the remote server of the third-party.

Optionally, the third-party acquisition functions are concealed. As used herein, the term concealed means, for example, scrambled, encrypted, modified, obscured, or other methods of concealing the identity of the acquisition function. When similar but concealed third-party acquisition functions provided by the same third-party are embedded in different software applications, the concealed acquisition functions may appear differently, even when performing the same or similar functions. The concealed third-party acquisition functions may be difficult to identify and associate with a particular third-party, for example, the concealed acquisition functions may have different names for similar (or the same) acquisition functions. Alternatively or additionally, the third-party acquisition functions are not concealed.

The concealed embedded third-party acquisition functions may be identified based on a preselected group of extracted classifying features, and/or other predefined values calculated from the software applications. The preselected group of classifying features and/or calculated values may correspond to the concealed acquisition functions. Extracting the features and/or calculating the values may identify the acquisition functions.

Classification of the software application based on embedded third-party data acquisition functions may be performed by suitable methods, for example, using a trained classifier, using a deterministic classifier, using a hash-table, using a mapping function, and/or other methods.

Optionally, identification of embedded third-party data acquisition functions is based on a selected group of classifying features extracted from the software application. As used herein, the term classifying features or classification features may refer to features that may be used to identify third-party data acquisition functions. The identified third-party data acquisition functions may be used to classify the software application, or perform other actions, such as displaying the associated third-party to the user and/or promoting the user for further action (e.g., delete the software application). In this manner, the terms classifying features or classification features are not necessarily limited to classification, but may serve other functions such as identification of the acquisition functions.

Optionally, classification of the software application is based on the selected classifying features extracted from the software application. Classification may be performed by a classifier. Optionally, a set of classifying features is extracted from training software applications, in order to generate classifiers for automatically classifying other software applications. The set of classifying features may correspond embedded third-party data acquisition functions within the software application.

Optionally, the selected group of classification features is a sub-set of the available features (all or some) that may be extracted from a software application. Alternatively or additionally, the group of classifying features is not selected based on the complete set of available features. Each or some of the classifying features may be selected independently.

Optionally, the classification features are selected based on a correspondence with the third-party acquisition functions. The classification features may have a one to one association with the third-party acquisition functions, and/or a certain feature may have an association with several third-party acquisition functions, and/or several features may have an association with a certain third-party acquisition function. Some classification features may be the same (or similar) for concealed variations of third-party acquisition functions, for example, features associated with the connection to remote server of the third-party. Some classification features may be different for the same (or similar) concealed variations of third-party acquisition functions, for example, features associated with different concealed variation names (or other identification) of the third-party acquisition function.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

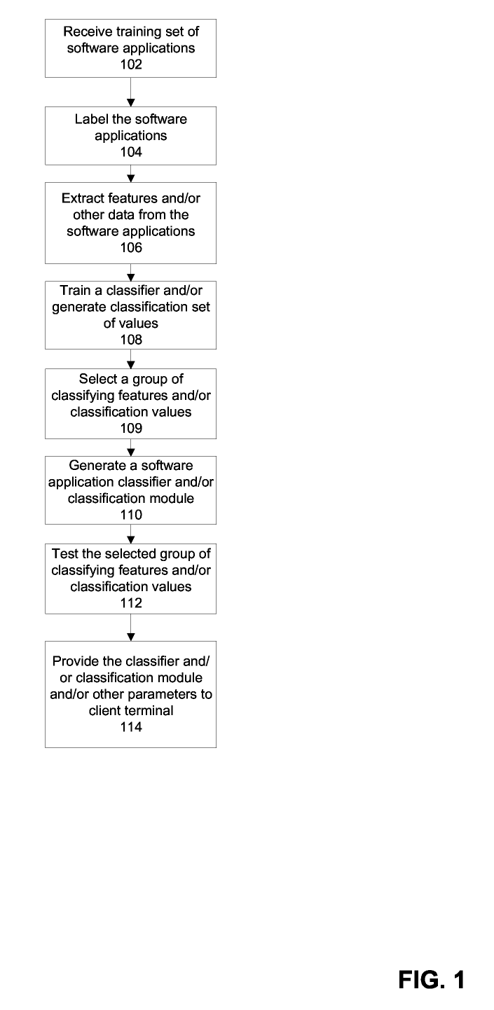

Reference is now made to FIG. 1, which is a method of generating classification data, in accordance with some embodiments of the present invention. Third-party data acquisition functions embedded within the software application may be identified based on the classification data. The software application may be classified based on the classification data.

As used herein the term classification data is not necessarily limited to data used for classification. The classification data may be used to identify third-party data acquisition functions embedded within software applications.

Optionally, the classification data is a selected group of classifying features, a mapping function, a hash-table, a statistical classifier, a deterministic classifier, and/or other statistical and/or deterministic classification methods. The method selects classification data (e.g., classifying features) based on an association with third-party acquisition functions embedded within software applications.

The acquisition functions may be concealed, which may appear differently (e.g., corresponding to different features) even when the concealed acquisition functions are from the same third-party and/or communicate with the same remote server and/or perform the same (or similar) functions. The method may generate the classification data (e.g., select classifying features) when the embedded third-party acquisition functions are concealed and/or not concealed.

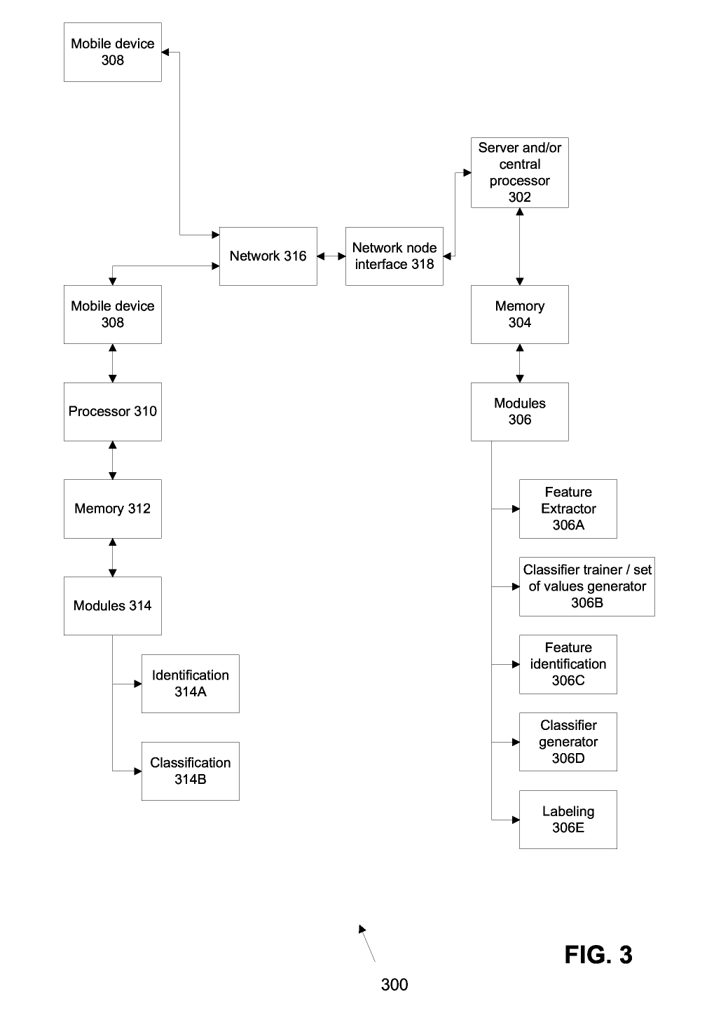

Reference is also made to FIG. 3, which is a system 300 for generating classification data (e.g., a classifier, a mapping function, a hash-table, and/or other statistical and/or deterministic methods) based on embedded third-party acquisition functions, identifying embedded third-party acquisition functions, and/or for classifying software applications based on the embedded third-party acquisition functions. Optionally, system 300 classifies software applications (e.g., adware) on a mobile device 308 (or other client terminal) during runtime. The method of FIG. 1 may be executed by the system of FIG. 3, for example, by a classification unit programmed to perform one or more blocks of the method.

The methods and/or systems may generate a software application classification data set (e.g., classifier) with high effectiveness in determining software applications with embedded third-party data acquisition functions, and/or identifying the acquisition functions therein. The high effectiveness is based, for example, on targeted classification using extracted features associated with the embedded third-party acquisition functions. In such a manner, a small set of features and/or data may need to be extracted and/or calculated to achieve the high effectiveness. Extraction and/or calculation of the small set of features and/or data may allow classification of software applications during run time, for example, before installation. Extraction and/or classification may be performed locally by a client terminal. The client terminal may have limited resources, such as limited processing capability and/or limited memory space. It is also noted that some of the classifying features and/or data calculations may be individually resource intensive, but that overall, the set of classifying features and/or data may not be resource intensive so that the classifying features and/or data may be locally extracted.

The generated classification data (e.g., classifier) may be able to detect software applications with acquisition functions from a single third-party, from multiple different third-parties, and/or with dynamic third-party acquisition functions that dynamically change the third-party server that is contacted.

The third-party acquisition functions may be provided as part of a software development kit (SDK) by the third-party, for example, function calls, application programming interfaces (API), or other acquisition functions for embedding within the software application.

The generated classification data (e.g., classifier) may be able to detect software applications with new variations of concealed third-party acquisition functions, that is, concealed versions that were not used in data generation (e.g., training). The new concealed acquisition function versions may be similar to acquisition functions used to generate the classification data (e.g., train the classifier). The classifier may correctly detect the presence of the new concealed acquisition function versions based on the similarity to the training version.

A first classifier may be trained using the large set of extracted features to generate weights and/or coefficients for each extracted feature. The set of classifying features may be selected from the first classifier, such as based on the generated weights. The software application classifier may be generated based on the selected classifying features of the first classifier.

Optionally, the classifier is a multi-class classifier, for identifying a certain third-party having third-party acquisition functions embedded in the software application. The multi-class classifier may classify the software application into one of several third-parties. Installation of software applications having third-party acquisition functions from certain undesired third-parties may be prevented. Alternatively or additionally, the classifier is a single-class classifier, for identifying third-party acquisition functions (from any third-party) embedded in the software application. The single-class classifier may classify the software application as having third-party acquisition functions embedded therein, or not.

Optionally, the classification features are identified from the larger set of extracted features. Optionally, the classification features are identified based on having high coefficient and/or weight values, optionally calculated by a machine learning algorithm. The high weight values may suggest high classification effectiveness of the related feature. As the third-party acquisition functions may be embedded in software applications for removal (e.g., adware) but not in software applications for installation (e.g., benign, non-adware, non-third-party), the features associated with the third-party acquisition functions may have high weights and/or high classification effectiveness in distinguishing between the adware and benign applications. In the case of the multi-class classifier, classification features may be selected for each of the different classification categories. The features with the highest weights and/or highest classification effectiveness may be selected for different feature vectors of the different classification categories. Alternatively or additionally, the classification features are identified based on cardinality. Groups of similar third-party acquisition functions may be identified, optionally based on the extracted features. For example, similar extracted features in extracted feature vectors are identified. The similar third-part acquisition functions may be identified by a distance metric.

System 300 includes a central processor 302 with a memory 304 for storing data modules 306 thereon. Optionally, central processor 302 is a network node.

Central processor 302 may be a remote server, part of or connected to a remote server, a distributed processing network, a desktop computer, or other resource intensive processing entities. Central processor 302 may have sufficient processing ability to train a classifier based on a full set of features extracted from software applications. The full set of features may be on the order of hundreds of thousands of features. Memory 304 may be large enough and/or fast enough to store the full set of extracted features.

Modules 306 may include one of more of: a feature extraction module 306A for extracting features, a training module 306B for training the classifier and/or generating the classification set of values, a feature identification module 306C for identifying the classification features, a classifier generator module 306D for generating the classifier based on the identified classification features, and/or a labeling module 306E for labeling the training software application. Modules 306 may execute one or more acts of the method of FIG. 1. The feature extraction may take place off-line, for example, as part of an initialization process to generate the selected group of classifying features before software application classification may proceed on the mobile devices.

Central processor 302 may communicate with one or more mobile devices 308, client terminals, Smartphones, tablet, portable media player, e-reader, or other devices. Mobile devices 308 may be resource limited, having smaller and/or less powerful processor 310, and/or smaller and/or slower memory 312. Mobile device 308 may have insufficient resources for local run-time extraction of a complete feature vector of features from the software application Modules 314 are stored on memory 312 for execution by processor 310.

Modules 314 may include a run-time identification module 314A for automatically identifying third-party data acquisition functions embedded within the software application. Module 314A may be a run-time feature extractor module 314A (or other third-party data acquisition function identifier modules) for extracting features from a software application for classification based on the selected group of classifying features. Modules 314 may include a run-time classification module 314B for classifying the software application, for example, based on the selected group of classifying features.

Central processor 302 and mobile device 308 may communicate with each other through a network 316. For example, through the internet, a local area connection, a wide area connection, a cellular connection, a wired connection, other networks, a Bluetooth™ connection, a USB cable, and/or combinations thereof. Central processor 302 and mobile device 308 may be remotely located from one another. Alternatively or additionally, central processor 302 and mobile device 308 may be local to one another, for example, central processor 302 is a desktop computer that is synchronized with a related mobile device 308.

Optionally, central processor 302 has a server node interface 318 for connecting to network 316, and/or for providing an interface for mobile device 308. Optionally, interface 316 provides the generated classifier to mobile device 308.

The software application classifier may be generated by central processor 302 and distributed to mobile device 308. Optionally, central processor 302 generates the selected group of classifying features, the classification data set, the selected coefficients, and/or the trained classifier. The selected group of classifying features and/or the trained classifier is then provided to client devices 308 for local run-time classification, for example, classification of software applications. Alternatively, the software application classifier is generated by mobile device 308, when mobile device 308 includes central processor 302, memory 304 and modules 306.

Referring back to FIG. 1, optionally, at 102, multiple software applications for training the classifier are received, for example, by central processor 302. The software applications may be manually provided by an operator of the system (e.g., the manufacturer), provided by software application manufacturers, automatically downloaded from the internet, provided by updates from mobile devices 308 that are part of system 300, and/or provided by other methods.

Optionally, at 104 the multiple software applications are labeled with a predetermined classification type and/or identification type based on desired software application classification categories. It is noted that as used herein, the terms classification type and identification type are interchangeable. Both terms may be used in the context of providing a type after classification of the software application, and/or after identification of the third-party data acquisition function.

Optionally, the software applications are labeled to generate a single-class classifier. Examples of single-class labels include: Adware, Goodware, Intrusive Adware, or other classification types may be used. Alternatively or additionally, the software applications are labeled to generate a multi-class classifier. The multi-class labels may include labels indicative of the different third-parties that provided the embedded acquisition functions, for examples, names of ad networks.

Certain software application may be labeled with multiple classes, for example, several third-parties (e.g., ad networks). It is noted that several third-parties may have acquisition functions in a single software application, in which case the classifier may detect the presence of most or all of the third-party acquisition functions, individually (i.e., single-class) or as a group (i.e., multi-class). The classifier may classifying the software application into one or several of multiple classes based on the different third-parties (i.e., multi-class), and/or into a single class when at least one third-party acquisition function has been detected (i.e., single-class).

Labeling may be performed manually (e.g., by the user) and/or automatically (e.g., by a labeling module 306E stored on memory 304). Labeling may be automatically performed, for example, using application programming interfaces (APIs) to label sources. Labeling may be manually performed, for example, using an interactive software module that requires user intervention.

Examples of labeling software applications include: previously labeled applications that were vetted by commercial companies, signature based tools for automatic labeling, mechanical turk methods to systematically analyze a large set of applications of the different classes, and/or other labeling methods.

Optionally, the output of the labeling module is a list of the software applications with a corresponding classification type. Labeling may be a 1:1 mapping, or may be other mapping methods that are not 1:1.

Alternatively or additionally, a non-supervised approach is used in which labeling is based on clusterization. Optionally, clusters are generated automatically using a non-supervised and/or a semi-supervised clustering software module. The classes taken from these algorithms may be assigned arbitrary names and/or meaningful names when correlations are identified.

Optionally, at 106, features and/or other data are extracted from the software applications, for example, by a feature extractor module 306A stored on memory 304. Optionally, a complete set of features is extracted from each application. Alternatively, individual or groups of features are extracted from each application, for example, as features are being evaluate for inclusion in the group of classifying features. Optionally, a feature vector is extracted.

Optionally, multiple feature extraction modules apply multiple feature extraction algorithms to extract the multiple features. For example, native operating system (OS) system calls, temporal polling, application monitoring, and/or other methods. Some features are acquired by a decompiling process, for example, translating the code (e.g., Java byte) into human readable code.

Optionally, the feature extraction module extracts data and/or meta data from the software applications. Optionally, the feature extraction module stores the extracted data, for example, in an extraction database stored on memory 304.

The extracted features may be any feature that describes the software application. The extracted features may be varied, containing information from different modalities. For example, the extracted features may contain static meta data regarding the application, for example, icon, name, rating or other features. In another example, the extracted features may contain information regarding the executable code and/or software package, for example, in the form of byte code, resources, permissions, or other features. In yet another example, another modality of features may include behavioral features, for example, temporal information regarding system calls, system usage, CPU usage, network utilization, or other features. The features may include suitable data and/or meta data that may be extracted from the software application and/or computed. Examples of extracted features include: application name, icon, rating, permissions, internal function calls, decompiled byte code, behavioral properties such as network, CPU, user interface(UI), and/or system calls usage, and/or other suitable quantifiable measures that may be obtained for the software application.

Extraction of the complete set of features may be time consuming, and/or CPU resource intensive. The feature extraction may take place off-line, not part of a run-time operation.

Optionally, the feature extraction module orders the features and/or stores the features in ordered buffers, for example, on memory 304. Optionally, the features are stored as feature vectors, which may be used for training the classifier. The features may be stored using other data structures, for example, a matrix, a list, or other suitable structures.

Extraction of the full set of features may not be possible during run-time on the mobile device. Extraction of the full set of features may take place at the central processor, independently of run-time operation of the mobile device, for example, before classification may proceed by the mobile device.

The extracted features may be stored, for example, within memory 304 or other suitable data repository, such as a local database.

Optionally, at 108, a classifier is trained based on the set of extracted features (block 106) and software application classification labeling (block 104).

Alternatively or additionally, a classification set of values is calculated based on the set of extracted features and/or other extracted data, and the respective labels of the software applications. Optionally, the classifier training generates the classification set of values. Other suitable methods may be used to generate the classification set of values. The set of values may be, for example, a vector of coefficients, a matrix of coefficients, a set of decision rules, a tree of decision rules, combinations thereof, and/or other parameters and/or other values. The nodes and/or positions in the vector and/or matrix may be attributed to specific features in the feature vector.

It is noted that the classifier and/or classification set of values may be used to identify third-party acquisition functions embedded within the software application, without necessarily classifying the software application. Classification is optional.

Optionally, a training module 306B (e.g., stored on memory 304) of a machine learning algorithm is applied to train the classifier and/or generate the classification set of values. A single-class classifier, and/or multiple single-class classifiers, and/or a multi-class classifier, and/or multiple multi-class classifiers may be trained. For example, a combination of classifiers may be trained to classify feature vectors, for example a cascade of classifiers, a boosting topology of classifiers, or a parallel classification scheme.

Optionally, learning module 306B performs the machine learning and/or classifier training and/or calculation of classification set of values.

Optionally, the classifier is trained based on supervised learning. Examples of software modules to train the classifier include: Neural Networks, Support Vector Machines, Decision Trees, Hard/Soft Thresholding, Naive Bayes Classifiers, or any other suitable classification system and/or method. Alternatively or additionally, the classifier is trained (and/or machine learning takes place) based on unsupervised learning, for example, k-Nearest Neighbors (KNN) clustering, Gaussian Mixture Model (GMM) parameterization, or other suitable unsupervised methods.

At 109, a group of classifying features is selected, for example, by a feature identification module 306C stored on memory 304. The selected classifying features correspond to the third-party acquisition functions embedded within the software applications. Alternatively or additionally, a selected group of classification values are selected.

Optionally, the set of values obtained during the classification training (block 108), and/or the complete extracted feature vector (block 106) are analyzed. Based on the analysis, the group of classifying features is identified. The classifying features may be identified based on a sub-set of values from the analyzed set of values. The set-of values correspond to the embedded third-party acquisition functions. Each selected classifying feature corresponds to one or more values from the identified sub-set of values, and corresponds to the embedded third-party acquisition functions.

The analysis to identify the sub-set of values may be performed by one or more suitable methods, and/or by a combination of the methods. The methods are designed to detect concealed third-party-acquisition functions embedded within the software applications. Some exemplary methods are now described.

In a first exemplary analysis method, selected values within the set of values are identified. Optionally, coefficients of the classifier are analyzed. The selected values may be selected based on a predetermined range, threshold, and/or by selecting the top few (e.g., predetermined number) of values. In an exemplary implementation, the highest absolute coefficients values of the classifier are selected. As the third-party acquisition functions are only embedded in software applications that the classifier is to detect, and not embedded in software applications that the classifier does not detect, coefficients corresponding to features extracted related to the embedded third-party acquisition functions may have higher values than other features, for example, features present in both software applications with and without embedded third-party acquisition functions.

The value set may be converted into absolute values. The value set may be sorted to assist with selection of the highest absolute values. The highest values may be selected based on a threshold, such as all values higher than a predefined threshold, or the top few values.

Selection of certain values as described above may be used for the single-class classifier, and/or may be extended to the multi-class classifier. To extend to the multi-class case, values may be selected for each set of labeled classified types within the value set. In an exemplary implementation, the value set may be divided based on the labeled classification types. For example, vector of different classification types are identified in the coefficient matrix. For each classification type, values may be selected as described above, optionally, by sorting and/or selecting the highest absolute values within each classification type.

In a second exemplary analysis method, features of similar third-party acquisition functions are identified based on cardinality. As used herein, the term cardinality means similarity of values within compared sets of values. The set of values may be compared to one another, for example, rows and/or columns within a matrix may be compared to each other. Similar values may suggest similar concealed third-party acquisition functions in different software applications. The feature vectors extracted from each software application may be compared to one another. Similar features may suggest similar concealed third-party acquisition functions in different software applications. For example, URLs that are very similar in some measure may be identified, and then selected based on an importance measure. In such a manner, variants of concealed third-party acquisition functions may be identified.

Optionally, similarities of features corresponding to similar third-party acquisition functions are measured using a distance metric, for example, a Jaccard distance. The degree of the distance metric may suggest when features correspond to concealed variants of third-party acquisition functions.

Optionally, at 110, a classifier for classification of software applications is generated, for example, by a classifier generator module 306D stored on memory 304. Optionally, the classifier is generated based on the selected group of classifying features. The classifier may be trained based on the selected group of classifying features. Optionally the classifier is a statistical classifier.

Alternatively or additionally, a classification module is generated, for example, a deterministic classifier, a mapping function, a hash-table, and/or other methods of classification.

Optionally, at 112, the group of classifying features, and/or the generated classifier (and/or the classification module and/or the selected classification values) are evaluated, for example, by an evaluation module 306 stored on memory 304. For example, classifier performance based on the pruned feature set is compared to classifier performance based on the complete feature set. In another example, classifier performance based on the group of classifying features is evaluated against a predefined threshold, such as a predefined level of accuracy in classification. Testing may be performed to evaluate one or more parameters, for example: certainty of the classification, ability to execute in run-time on the mobile device, time for execution, CPU utilization, memory requirement, and/or other evaluation criteria.

Optionally, the selected group of classifying features is tested for execution during operation run-time on a mobile device (or other resource limited client terminal). The group of classifying features may be tested to verify calculation and/or extraction of the features during run-time on the mobile device. Extraction of the full set of features may not be possible on the mobile device, during run-time and/or based on the CPU and/or memory requirements. Extraction of the group of classifying features may be possible on the mobile device during run time. Performing the classification on the extracted feature vector may be a simple, resource inexpensive mathematical operation. For example, the selected group is tested to verify that the client terminal will be able to classify the software application within a reasonable time limit, for example, in less than 5 seconds before installation.

The analysis method may be selectively adjusted based on the testing. Alternatively or additionally, the members of the group of classifying features may be adjusted. For example, if testing indicates inability to execute on the mobile device, additional features may be removed from the group. For example, if testing indicates inadequate classification certainty, additional features may be added back to the group to improve classification performance.

Optionally, at 114, the group of classifying features, the selected values (e.g., coefficients), and/or the trained classifier are provided to the mobile device. For example, the mobile device downloads the trained classifier from the central server via network node interface 318. A synchronization module 314 on the mobile device (e.g., memory 312) may detect an update of the group of classifying features and/or the classifier, and automatically download the updated version to the mobile device. The central server may automatically upload the latest version to the mobile device. Other methods of providing the trained classifier to the mobile device may be used.

The group of classifying features, selected coefficients and/or trained classifier may be provided over network 316, over a cable, through a local wireless connection, on a computer readable media (e.g., memory card, CD, or other media), or using other methods.

The group of classifying features, selected coefficients and/or trained classifier are provided to the mobile device for classification of software applications by the mobile device.

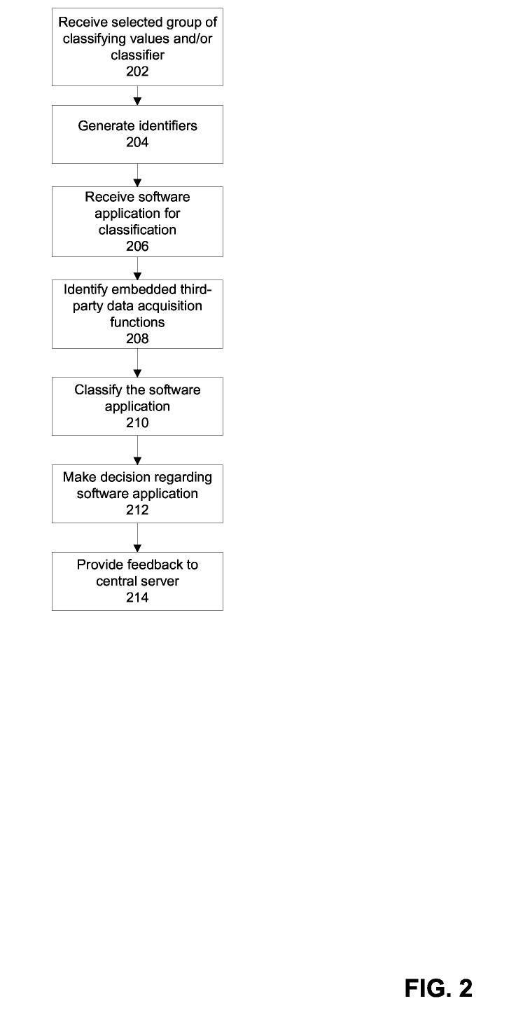

Reference is now made to FIG. 2, which is a flowchart of a method of identifying embedded third-party acquisition functions, and/or classifying software applications based on embedded third-party acquisition functions, in accordance with some embodiments of the present invention. The method of FIG. 2 may be executed by mobile device 308 of FIG. 3. The method of FIG. 2 may identify software applications having third-party acquisition functions embedded therein, optionally when the third-party acquisition functions are concealed.

Optionally, at 202, the group of classifying features, and/or the trained classifier, and/or classification values (e.g., coefficients) related to the classifying features, is received by the mobile device (or other client terminal), for example, by the synchronization module and/or through network node interface 318. The group of classifying features may be received from the central server.

Alternatively or additionally, a list of coefficients or other classification values are received by the mobile device.

The received classifier evaluates a software application based on a selected group of classifying features, the classifying features selected from features based on third-party acquisition functions embedded within the software application. The third-party acquisition functions may communicate with a remote third-party server. The embedded third-party acquisition functions may be concealed.

Other received classification modules and/or classification values may be used to classify the software application based on the embedded third-party data acquisition function.

Optionally, at 204, third-party data acquisition function identifier modules 314A (e.g., feature extractor modules) are generated at the mobile device. Alternatively or additionally, the identifier modules 314A are pre-stored and/or pre-loaded modules on the mobile device, for example, having been preprogrammed by the manufacturer. Alternatively or additionally, the identifier modules 314A are downloaded from the central server.

Optionally, the identification (e.g., feature extractor) modules are automatically built and coded based on the classification values (e.g., classification features) that have been selected by the central processor. Optionally, the identification modules (e.g., feature extractors) are designed for run time execution using the limited resources available at the mobile device.

Optionally, at 206, a software application is received at the mobile device, for example, the software application is downloaded from the internet, loaded using physical computer readable media, uploaded by a third-party, or other methods of receipt. Optionally, the software application is requesting (automatically or manually) to be installed on the mobile device.

At 208, the embedded third-party data acquisition functions within the software applications are identified, for example, by identification module 314A. Optionally, the group of classifying features is extracted from the software application, for example by the generated feature extraction modules. The group of classifying features may be associated with the embedded third-party data acquisition functions. Extraction of the classifying features may identify the presence of the embedded third-party data acquisition functions. Other methods may be used to identify the embedded third-party data acquisition functions, for example, based on calculations for the hash-table, for the mapping function, and/or other methods.

Optionally, the identification and/or extracting is performed locally by the client terminal during run time.

Optionally, the identified embedded third-party acquisition functions are provided, for example, to the user (e.g., displayed), to other software application modules (e.g., for further processing, for classification), and/or are stored.

Optionally, at 210, the software application is classified based on the identified embedded third-party data acquisition functions (optionally the extracted group of classifying features), for example, by a classification module 314B stored on memory 312. Optionally, classification module 314B labels the software application with the classification category.

Optionally, the software application is classified using the single classification category, for example, as adware or other. Alternatively or additionally, the software application is classified using the multi-classification categories, for example, into one of multiple third-parties (e.g., ad networks) or other.

Optionally, the software application is classified by applying the trained classifier received from the central server. Alternatively or additionally, the software application is classified based on the group of classifying features that have been computed by the feature extractor (block 208). Alternatively or additionally, the classification is based on the received coefficients that have been computed by central processor 302, for example, when classification is performed based on a suitable coefficient related method. Alternatively or additionally, the classification is performed by other suitable methods, for example, by applying the deterministic classifier, the hash-table, the mapping function, and/or other methods.

Optionally, classification module 314B computes the classification using a statistical classifier set, a deterministic classifier set, or combinations thereof. Classification may be computed by a single method, a cascade of simple classifiers, a dual or a multi-class scenario, or other combinations of different classification methods.

Optionally, a certainty of the classification is provided, for example, the estimated probability that the classification is correct.

Optionally, at 212, a course of action is decided for the software application based on the identified third-party acquisition functions and/or based on the automated classification. Optionally, the software application is installed on the mobile device, for example, if the classification type is determined to be not related to adware, and/or related to certain allowable third-parties. Alternatively, the software application is not installed, deleted, flagged, or otherwise prevented from functioning on the mobile device, for example, if the classification type is determined to be adware, and/or related to certain prohibited third-parties.

The decision to install or delete the software application may be performed manually by the user, and/or automatically by a removal module.

Optionally, at 214, the mobile device reports back to the server. Optionally, the classification type outcome is reported.

Optionally, classifying features and/or other classification values associated with the embedded third-party concealed acquisition function are reported. Optionally, the concealed version is a new version, not previously known by the classifier. In such a manner, detection of new concealed versions of third-party acquisition functions may be incorporated into an updated version of the central classifier and/or classification values, and may be distributed to users for identification of the new concealed acquisition functions.

Reporting is performed, for example, by sending electronic messages through network 316. Optionally, information regarding the software application is sent back as part of a feedback loop.

Optionally, the central server learns about the existence of new software applications, new third-parties, new third-party acquisition functions, and/or new variations of concealed third-party acquisition functions, based on the feedback provided from the mobile device.

Optionally, the central server re-labels or confirms the labeling of existing software applications based on the provided feedback. Optionally, the classification labeling is re-enforced based on manual or semi-automatic methods.

The method of FIG. 2 may be automatically executed by software, for example, the mobile device automatically updates itself with the latest feature set, automatically detects software trying to install itself, automatically classifies the software, and/or automatically removes possibly harmful software. Some blocks of the method may be performed manually by the user, for example, requesting an update of the feature set, running the classification program, and/or other blocks.

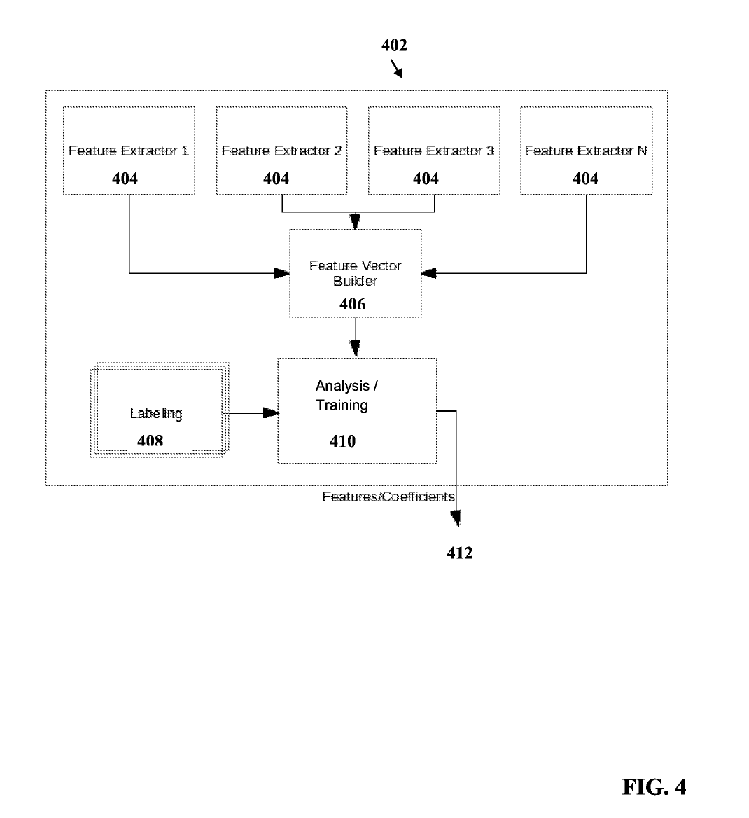

Reference is now made to FIG. 4, which is a schematic block diagram of an exemplary server 402 for generating classifiers and/or classification values for identifying embedded third-party acquisition functions, in accordance with some embodiments of the present invention. The interaction and/or operation of the modules within server 402 is based on the method of FIG. 1, and/or central processor 302 of FIG. 3.

Optionally, server 402 is a network connected computer node.

Multiple feature extractor modules 404 extract a complete set of features from each training software application. The extracted features are optionally combined into a feature vector by a feature vector builder 406.

A labeling module 408 labels the software applications. Labeling may be based on generating a single class classifier, or a multi-class classifier.

A first classifier may be trained by a training module 410, based on the extracted features (optional feature vector) and associated labels of the software applications.

An analysis module 410 selects the values (e.g., coefficients) and/or classification features that correspond to the embedded third-party acquisition functions based on the first classifier.

The selected classification features 412 and/or selected coefficients 412 (or other values) are provided as an output of server 402. The classification features and/or values may be used to train a software application classifier for classifying software applications based on the embedded third-party acquisition functions.

The classifying features 412, and/or coefficients 412, and/or software application classifier are provided to the client terminal for performing classification of the software applications to identify software applications related to the third-parties.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems will be developed and the scope of the terms client terminal, mobile device, server, network, third-party, software application and classifier are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer-implemented method for identifying functions within software applications, comprising:
receiving a software application for identification;
automatically identifying third-party data acquisition functions embedded within the software application, the third-party data acquisition functions communicating with a remote third-party server; and
providing the identified third-party data acquisition functions for the software application.

2. The method of claim 1, further comprising automatically classifying the software application based on the identified third-party data acquisition functions.

3. The method of claim 1, wherein automatically identifying comprises automatically identifying concealed embedded third-party data acquisition functions based on a preselected group of classification features extracted from the software applications, the preselected group of classifying features corresponding to the concealed embedded third-party data acquisition functions.

4. The method of claim 2, wherein classifying comprises classifying by a classifier, the classifier evaluating the software application based on a selected group of extracted classifying features, the extracted classifying features selected from a plurality of features so that the extracted classification features are based on third-party data acquisition functions embedded within the software application.

5. The method of claim 1, wherein the third-party data acquisition functions are provided as part of a software development kit (SDK) for development of the software application.

6. The method of claim 1, wherein the third-party includes at least one member of a group consisting of: ad network, advertiser, hacker, spy, market information collector, malicious party.

7. The method of claim 1, wherein the third-party data acquisition functions are function calls to the third-party remove server and/or application programming interfaces (API) communicating with the third-party remote server.

8. The method of claim 1, wherein the software application is received at a client terminal for local run-time classification by the client terminal.

9. The method of claim 2, further comprising providing a classification type denoting one of a plurality of ad networks.

10. The method of claim 1, further comprising installing or removing the software application based on the identified third-party data acquisition function.

11. A computer-implemented method for generating data for identifying embedded third-party data acquisition functions within software applications on a client terminal, comprising:
identifying, at a central server, a plurality of features from each of a plurality of training software applications, each of the plurality of training software applications contains third-party data acquisition functions embedded therein, the third-party data acquisition functions communicating with a remote third-party server, the embedded third-party data acquisition functions being concealed so that similar third-party data acquisition functions corresponding to a same third-party have different identities between at least two training software applications embedding concealed third-party data acquisition functions from the same third-party;
identifying a group of classifying features from the plurality of features, the group of classifying features corresponding to the embedded third-party data acquisition functions within each of the plurality of training software applications; and
providing the group of classifying features to a client terminal, for identification of third-party data acquisition functions embedded within a software application locally by the client terminal.

12. The method of claim 11, further comprising generating a classifier for evaluating software applications based on the group of classifying features; and providing the classifier to a client terminal, for feature extraction and classification of a software application locally by the client terminal.

13. The method of claim 11, wherein the group of classifying features is selected to correspond to concealed embedded third-party data acquisition functions.

14. The method of claim 12, wherein the classifier is a multiclass classifier for classifying the software application into one of a plurality of different third-parties.

15. The method of claim 12, wherein the classifier is a single-class classifier for classifying the software applications as having third-party data acquisition functions embedded therein or not.

16. The method of claim 11, wherein identifying a group of classifying features from the plurality of features comprises:
labeling each of the plurality of training software applications with a predetermined classification category;
generating a set of values, by applying a machine learning software module to the plurality of features and corresponding labels, certain values within the set of values corresponding to certain features of the plurality of features;
identifying the group of classifying features based on a sub-set of values from the set of values, each classifying feature from the group of features corresponding to at least one value from the sub-set of values, the set-of values corresponding to the embedded third-party data acquisition functions.

17. The method of claim 16, wherein the set of values includes at least one member of a group consisting of: a vector of coefficients, a matrix of coefficients, a set of decision rules, a tree of decision rules.

18. The method of claim 16, wherein identifying comprises identifying the sub-set of values as the highest ranked absolute values of the set of values.

19. The method of claim 18, further comprising identifying classifying types of each of the values of the set of values, and identifying comprises selecting the highest ranked absolute values of the set of values for each identified classification type.

20. The method of claim 16, wherein identifying comprises identifying groups of similar third-party data acquisition functions based on cardinality within the set of values.

21. A system for identifying third-party data acquisition functions embedded within software applications, comprising:
a client terminal comprising:
a client processor;
a first non-transitory memory having stored thereon program modules for local instruction execution by the client processor, comprising:
an identification module for automatically identifying third-party data acquisition functions embedded within the software application, the third-party data acquisition functions communicating with a remote third-party server.

22. The system of claim 21, further comprising a classification module for automatically classifying the software application based on the identified third-party data acquisition functions embedded therein, to generate a classification type for the software application.

23. The system of claim 21, wherein the client terminal further comprises:
a client network node for communicating with a server network node interface over a network.

24. The system of claim 21, further comprising:
a network connected central server;
a second non-transitory memory having stored thereon program modules for instruction execution by the central server, comprising:
a module for generating classification data for identifying third-party data acquisition functions embedded therein, and/or classifying software applications based on third-party data acquisition function embedded therein;
a server network node interface for providing the classification data to a client terminal, for identification of third-party data acquisition functions within a software application and/or classification of the software application locally by the client terminal.

25. The system of claim 24, wherein the network connected central server further comprises:
a module for identifying a plurality of features from each of a plurality of training software applications, each of the plurality of training software applications contains third-party acquisition functions embedded therein, the third-party acquisition functions communicating with a remote third-party server, the embedded third-party acquisition functions being concealed so that similar third-party acquisition functions corresponding to a same third-party have different identities between at least two training software applications embedding concealed third-party acquisition functions from the same third-party;
a module for identifying a group of classifying features from the plurality of features, the group of classifying features corresponding to the embedded third-party acquisition functions within each of the plurality of training software applications; and
a module for generating a classifier for evaluating software applications based on the group of classifying features.

26. The system of claim 21, wherein the client terminal further comprises:
a feature extractor module for local run-time execution by the client processor, the feature extractor module programmed for extracting features from a software application based on a group of classifying features received from a central server.

27. The system of claim 24, further comprising a labeling module for labeling of software application with one of a plurality of ad networks, the labeled software applications used for generating a multi-class version of a classifier, the labeling module stored on the second memory.

28. The system of claim 24, further comprising a feature extractor module stored on the second memory, the feature extraction module for extraction of features of software applications into complete feature vectors, the group of classifying features selected from the complete feature vector.

29. The system of claim 21, wherein the client terminal is resource limited, having insufficient resources for local run-time extraction of a complete feature vector of a plurality of features from the software application.

30. The system of claim 23, wherein the client terminal includes at least one member of a group consisting of: mobile phone, Smartphone, tablet, portable media player, e-reader.
